(19) United States
(12) Patent Application Publication
(10) Pub. No.: US 2008/0094836 A1
(43) Pub. Date: Apr. 24, 2008

(54) LED lighting device

(75) Inventors: San-Woei Shyu, Taipei (TW); Ching-Yuan Lin, Taipei (TW)

Correspondence Address: TROXELL LAW OFFICE PLLC, SUITE 1404, 5205 LEESBURG PIKE, FALLS CHURCH, VA, 22041, US

(73) Assignee: E-PIN OPTICAL INDUSTRY CO., LTD.

(21) Appl. No.: 11/583,981

(22) Filed: Oct. 20, 2006

(51) Int. Cl. F21V 7/00

(52) U.S. Cl. 362/247

(57) ABSTRACT

An LED lighting device applied to laser beam printers (LBP), scanners, or multi-function printers (MFP) includes a lighting source, a focusing cap and a strip lens. The lighting source is composed of a plurality of LEDs that are arranged on the circuit board in a certain interval or in non-isometric, linearly or nonlinearly. The focusing cap disposed with a plurality of reflective areas is arranged between the lighting source and the lens. Each of the reflective areas corresponds to each of the LEDs and each of the reflective areas is arranged with a reflective surface according to types or lighting patterns of the LED. The strip lens is disposed on outer side of the focusing cap. The cross section of the lens includes an inner and an outer (or an upper and a lower) optical surfaces, respectively faces the plurality of LEDs and the scanned object. By disposition of the focusing cap that reflects and focuses light, evenness as well as brightness of the scanning light is effectively improved and assembling of the device is simplified. Therefore, manufacturing cost o the lighting device is reduced.

### BACKGROUND OF THE INVENTION

The present invention relates to an LED lighting device, especially to a lighting device applied to laser beam printers (LBP), scanners, or multi-function printers (MFP) that includes a focusing cap arranged between a lighting source and a lens so as to simplify assembling of the device as well as reduce manufacturing cost.

Generally, laser beam printers (LBP), scanners, copy machines or multi-function printers (MFP) include a lighting device that provides light for scanned objects such as documents. Most of conventional lighting devices are tubular lamps. A slot is disposed on a housing outside the lamp so that part of light emitted from the lamp projects outwards through the slot as scanning light for scanned objects. However, such kind of lamp is a specific kind of lamp with higher cost and easy to get broken. Thus the manufacturing cost of the lighting device is increased. Moreover, the tubular lamp is with fixed specification such as length or color so that the evenness and length of the scanning light are restricted. Further the scanning quality and efficiency have been affected. For improving above shortcomings of conventional tubular lighting source, refer to Taiwanese patent No. 208033, a lighting device that uses a plurality of LEDs as light source is revealed by the applicant of the present invention. However, there are various types of LED with different lighting patterns such as side view LED disclosed in Taiwanese publication No. 200305291. There are more choices for LED used in lighting device. Thus the applicant discloses the present invention for improving LED lighting device.

### SUMMARY OF THE INVENTION

Therefore it is a primary object of the present invention to provide a LED lighting device applied to laser beam printers (LBP), scanners, copy machines or multi-function printers. The lighting device consists of a lighting source, a focusing cap(cover) and a strip lens. The lighting source includes a plurality of LED (light emitting diode). The focusing cap is disposed between the lighting source and the lens and is having a plurality of reflective areas corresponding to the LED respectively. A reflective surface is arranged inside each of the reflective areas according to lighting patterns or types of the LED. The strip lens having an inner and an outer (or upper and lower) optical surfaces is set on outer side of the focusing cap. The inner and the outer optical faces respectively face the LED and scanned object. Therefore, evenness and brightness of the scanning light of the lighting device are improved and assembling of the lighting device is simplified so as to reduce cost of the lighting device.

It is another object of the present invention to provide a LED lighting device in which the plurality of LED is arranged in a certain interval or in non-isometric and/or linearly or nonlinearly on a circuit board (substrate). In combination with reflective surface of each of the reflective areas inside the focusing cap(cover) and various types of LED with different lighting patterns, the arrangements and assembling patterns of LED are increased. The assembling of lighting device is simplified and there are more choices of lighting device for users.

### BRIEF DESCRIPTION OF THE DRAWINGS

FIG. 1 is a perspective view of an embodiment according to the present invention;

FIG. 2 is an explosive view of the embodiment in FIG. 1 according to the present invention;

FIG. 3 is a schematic drawing showing cross section of the embodiment in FIG. 1 according to the present invention;

FIG. 4 is a cross sectional view of the embodiment having a lens with two convex optical surfaces in FIG. 1;

FIG. 4A is a cross sectional view of the embodiment having a lens with a flat optical surface and a convex optical surfaces in FIG. 1;

FIG. 4B is a cross sectional view of the embodiment having a lens with a concave optical surface and a convex optical surfaces in FIG. 1;

FIG. 5 is a schematic drawing showing light pathway of a LED light module of the embodiment in FIG. 4;

FIG. 6 is a schematic drawing showing cross section of another embodiment in accordance with the present invention.

### DETAILED DESCRIPTION OF THE PREFERRED EMBODIMENT

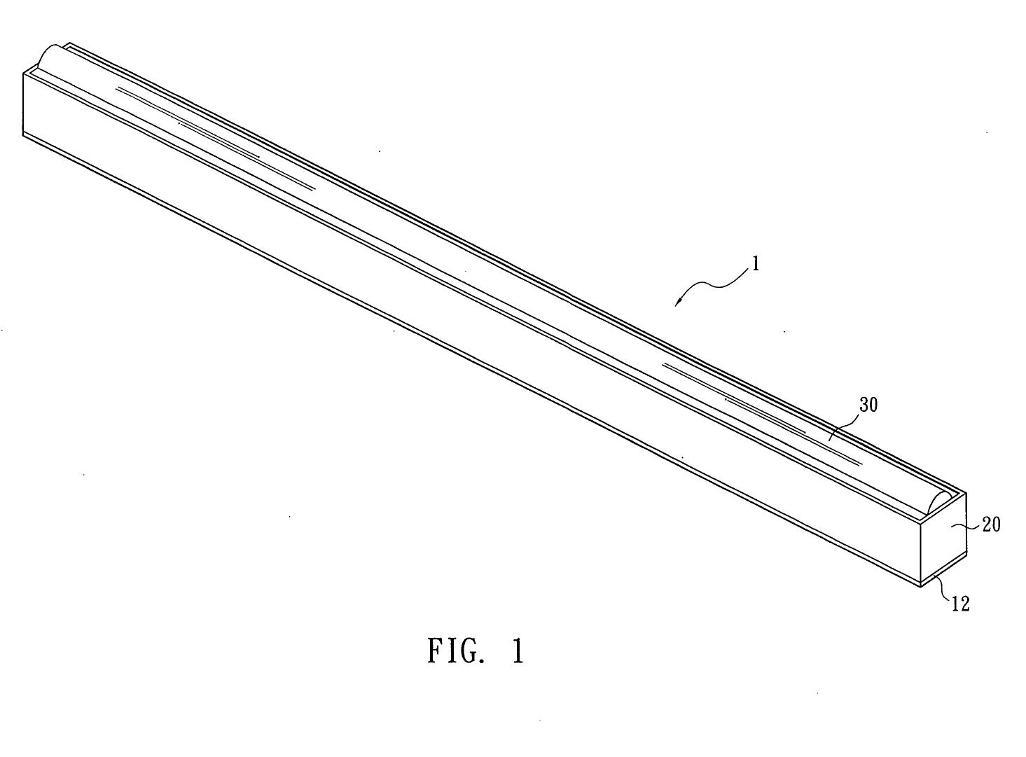

Refer from FIG. 1 to FIG. 5, a LED lighting device 1 according to the present invention applied to laser beam printers (LBP), scanners, copy machines or multi-function printers mainly consists of a lighting source 10, a focusing cap 20 and a strip lens 30. The lighting source 10 includes a plurality of LED arranged on a circuit board (substrate) 12. There is no restriction on arrangement of the LED. It can be in a certain interval or in non-isometric, linearly or nonlinearly, so that the LEDs 11 are controlled by the circuit board 12.

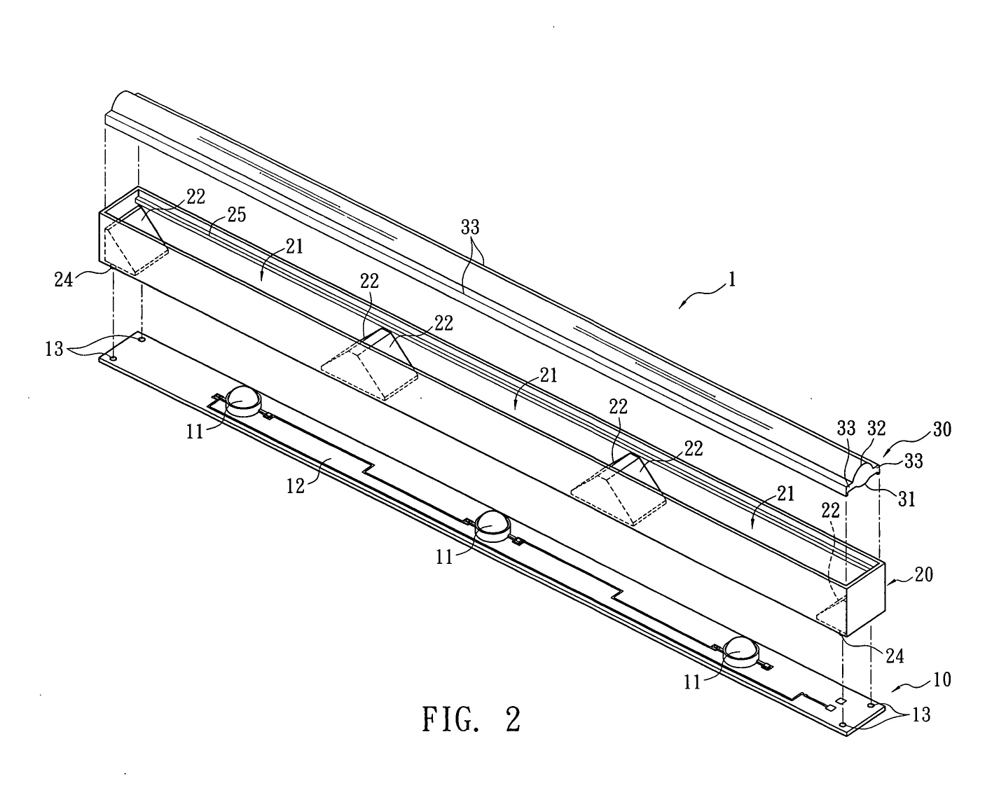

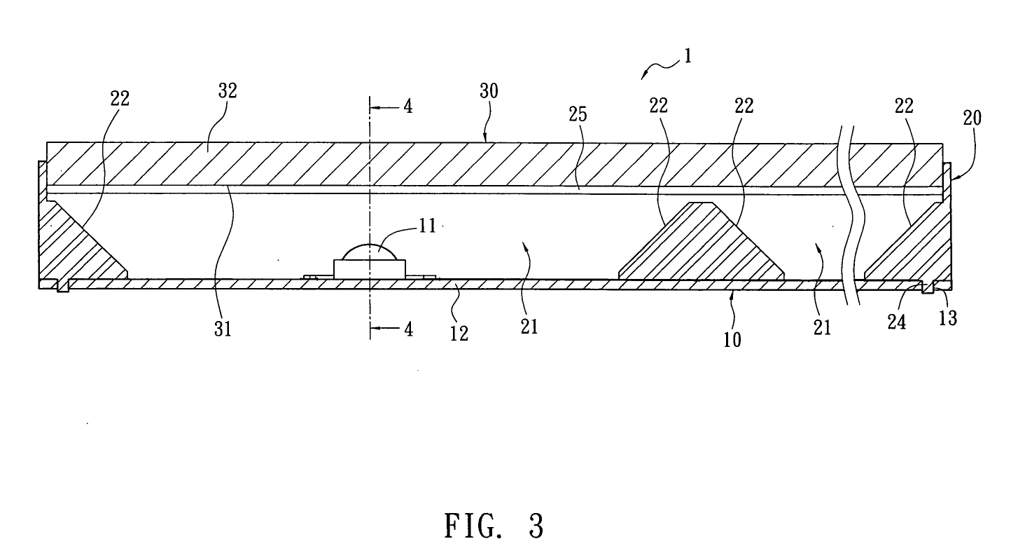

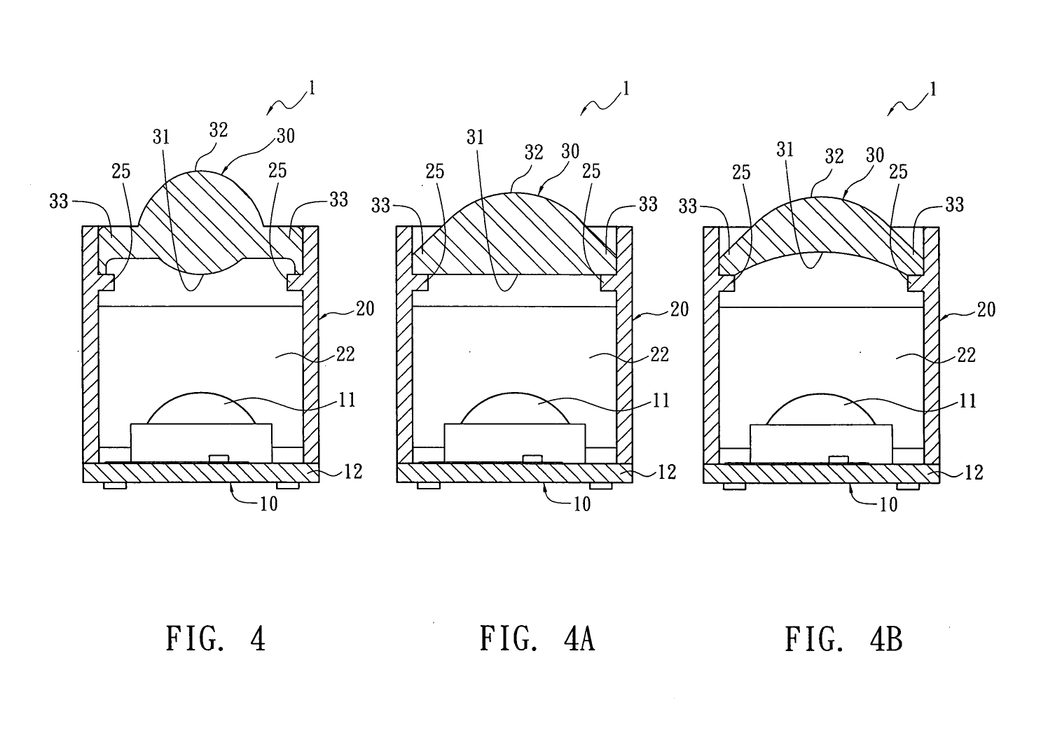

The focusing cap 20 is a rectangular housing with an upper opening and a lower opening. It can be made by plastic injection and encloses the lighting source 10 therein so that the plurality of LED 11 is also mounted in the focusing cap 20. Moreover, a plurality of reflective areas 21 corresponding to the LED 11 of the lighting source 10 is arranged on four sides of the housing of the focusing cap 20. That means each of the LED 11 is arranged inside a space with the reflective area 21. Each of the reflective areas 21 is disposed with a slanting reflective surface 22. And the reflective surface 22 is arranged in a set with a right and a left reflective surface, as shown in FIG. 2 & FIG. 3. The reflective surface 22 is made from plastic material coated with a glossy membrane by electroplating. As to the inclined angle of the slanting reflective surface 22, it depends on the type of the LED 11 such as height of the lighting source or the lighting pattern of the LED 11 such as projecting angle of the side view LED. Thus the evenness and brightness of the scanning light generated from the LED 11 are improved. The lens 30 is a long strip with the same cross section (as shown in FIG. 4). There is no restriction on the manufacturing material and molding method of the lens 30. For example, it can be made from PMMA80N by die-casting. The shape and size of the lens 30 are designed according to the focusing cap 20 so that the lens 30 can be disposed and located inside the focusing cap 20.

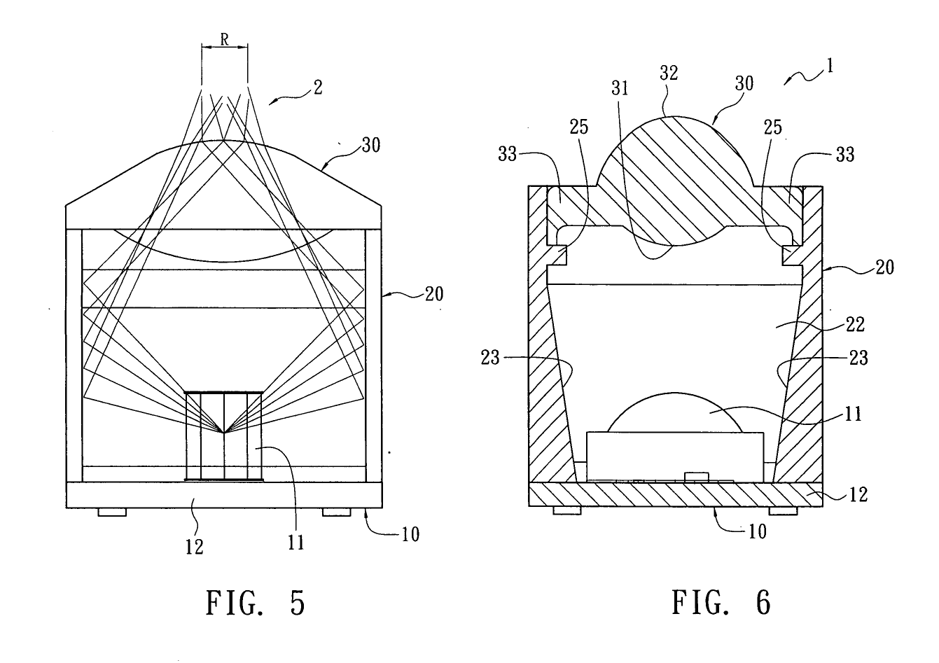

Moreover, an inner and an outer (or upper and lower) optical surfaces 31, 32 respectively facing the lighting source 10 and the scanned object are arranged on a cross section of the lens 30 so that light from the lighting source 10 directly projects onto the optical surface 31 or is reflected by the slanting reflective surface 22 of the reflective area 21 and then is projected to the optical surface 31. Next the light is refracted by the lens 30 and then is projected outwards from the optical surface 32 so as to form scanning light for scanning the object, as shown in FIG. 5.

The LED lighting device 1 according to the present invention features on the focusing cap 20 arranged between the lighting source 10 and the lens 30. The focusing cap 20 is disposed with a plurality of reflective areas 21 and reflective surfaces 22 respectively corresponding to the plurality of LED 11 of the lighting source 10 so as to reflect and focus light. In combination with refraction of the lens 30, evenness and brightness of LED scanning light 2 are improved effectively. Moreover, the manufacturing cost of the lighting device 1 is reduced.

There is no restriction on layout of the LED 11 on the circuit board 12. It can be designed according to the effective area of the scanning light or requirements of evenness and brightness of the light projected from the LED 11. For example, the LED 11 can be arranged on the circuit board 12 in a certain interval or in non-isometric, linearly or nonlinearly so that selectivity of the LED11 is increased. Moreover, the lighting source 10 is formed by various types of LED 11 or the LED 11 with different lighting patterns so that the arrangements and assembling patterns of the LED 11 are increased. Therefore, the assembling of the lighting device 1 is simplified and the lighting device 1 is more versatile.

There is no limit on shape and optical variables of an inner and an outer (or a lower and an upper) optical surfaces 31, 32 of the lens 30. They can be varied according to requirements of different pathways of light. The light from the lighting source 10 is projected onto the optical surface 31 directly or through reflection of the reflective surface 22 of each of the reflective areas 21 and then projected onto the optical surface 31. The lens 3.0 can be biconvex (both of the optical surfaces 31, 32 are convex) in FIG. 4, or flat-convex (the optical surface 31 is flat while the optical surface 32 is convex) in FIG. 4A, or concaveconvex (the optical surface 31 is concave while the optical surface 32 is convex) as shown in FIG. 4B.

Refer to FIG. 5, general length (R) required for the scanning light 2 is not too wide and the distance between the scanned object (not shown in figure) and lens is limited so that there is no need to restrict the scanning light 2 through the lens 30 and projected outwards from the optical surface to parallel light. It can be cross light that achieves evenness and brightness required for scanning, as shown in FIG. 5. Thus optical design of the lens 30 is simplified.

Refer to FIG. 6, besides a set of right and left slanting reflective surface 22 disposed transversely on the each of the reflective areas 21, a set of slanting reflective surface 23 can also arrange Longitudinally so as to raise evenness and brightness of the LED 11 scanning light.

Refer to FIG. 2, the focusing cap 20 is disposed and located on the lighting source 10 and there is no restriction on assembling way between the focusing cap 20 and the lighting source 10. A locating pin 24 is arranged on bottom of the slanting reflective surface 22 on left and right ends of the focusing cap 20 while a corresponding locating hole 13 is disposed on the circuit boards 12 (substrate). By assembling of the locating pin 24 and the locating hole 13, the focusing cap 20 is disposed and located on the lighting source 10.

Refer to the FIG. 4, FIG. 4A & FIG. 4B, there is no limit on assembling way between the lens 30 and the focusing cap 20. Two symmetrical stopping slots 25 are arranged on front and rear edges of an opening on top of the focusing cap 20 while a front and a rear flanges 33 are disposed on the lens. Thus by the front and a rear flanges 33 mounted and stopped against the stopping slots 25 and further being glued with each other, the lens 30 is located and disposed on the focusing cap 20.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An LED lighting device applied to laser beam printers, scanners, copy machines or laser beam printers comprising a lighting source, a focusing cap and a lens; wherein
the lighting source having a plurality of LEDs that are arranged on a circuit board in a certain interval or in non-isometric while the LEDs are controlled by the circuit board;
the focusing cap is a rectangular housing with an upper opening and a lower opening and enclosing the lighting source therein so that the plurality of LED is mounted therein; a plurality of reflective areas respectively corresponding to the LED of the lighting source is arranged inside the focusing cap and each of the LED is arranged in one of the reflective areas; the reflective area is disposed with a set of two slanting reflective surfaces having a right reflective surface and a left reflective surface that are arranged transversely along the focusing cap;
the lens is a long strip with the same cross section and the shape and size of the lens are designed according to the focusing cap so that the lens is disposed and located inside the focusing cap; an inner and an outer optical surfaces respectively facing the lighting source and the scanned object are arranged on a cross section of the lens so that light from the lighting source directly projects onto the inner optical surface or is reflected by the slanting reflective surface of the reflective area and then is projected to the inner optical surface; next the light is refracted by the lens and then is projected outwards from the outer optical surface so as to form scanning light;
in accordance with above structure, by focusing of the focusing cap disposed between the lighting source and the lens and reflection of the reflective areas as well as reflective surfaces corresponding to the LED of the lighting source, evenness and brightness of the scanning light are improved and manufacturing cost of the lighting device is reduced.

2. The LED lighting device as claimed in claim 1, wherein the plurality of LED is disposed on the circuit board linearly or non-linearly.

3. The LED lighting device as claimed in claim 1, wherein the focusing cap is made from plastic by injection molding.

4. The LED lighting device as claimed in claim 1, wherein the reflective surface is a reflective glossy membrane made by electroplating.

5. The LED lighting device as claimed in claim 1, wherein slanting angle of the slanting reflective surface is designed according to types or lighting patterns of the LED module.

6. The LED lighting device as claimed in claim 1, wherein the inner and outer optical surfaces of the lens are both convex surfaces.

7. The LED lighting device as claimed in claim 1, wherein the inner optical surface of the lens is a flat surface while the outer optical surface is a convex surface.

8. The LED lighting device as claimed in claim 1, wherein the inner optical surface of the lens is a concave surface while the outer optical surface is a convex surface.

9. The LED lighting device as claimed in claim 1, wherein the reflective area having a set of a front and a rear slanting reflective surfaces of the focusing cap is disposed transversely thereof.

10. The LED lighting device as claimed in claim 1, wherein a locating pin is arranged on bottom of the left and right ends of the focusing cap while a corresponding locating hole is disposed on the circuit board so that the focusing cap is disposed and located on the lighting source by assembling of the locating pin and the locating hole.

11. The LED lighting device as claimed in claim 1, wherein two symmetrical stopping slots are arranged on front and rear edges respectively of an opening on top of the focusing cap while a front and a rear flanges 33 are disposed on the lens so that the lens is located and disposed on the focusing cap by the front and a rear flanges mounted and stopped against the stopping slots.
